(19) United States
(12) Patent Application Publication
(10) Pub. No.: US 2005/0052156 A1
(43) Pub. Date: Mar. 10, 2005

(54) Wireless charging mat with integrated interface connection

(76) Inventor: Frank Liebenow, Jefferson, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/762,995

(22) Filed: Jan. 22, 2004

Related U.S. Application Data
(60) Provisional application No. 60/500,004, filed on Sep. 4, 2003.

(51) Int. Cl. H02J 7/00

(52) U.S. Cl. 320/128

(57) ABSTRACT

A charging mat with embedded communications capabilities for providing power to a portable device which is set upon the charging mat and for providing connection to various peripheral devices while the portable device rests upon the charging mat. It is envisioned that by including the communications capabilities within a charging mat, the charging mat technology will provide most capabilities currently provided by docking stations and docking bars.

### BACKGROUND OF THE INVENTION

1. Field of the Invention

This application is related to, and claims priority to U.S. provisional application No. 60/500,004, filed Sep. 4, 2003, entitled “WIRELESS CHARGING MAT WITH INTEGRATED INTERFACE CONNECTION”, Attorney Docket Number P1962US00, the entirety of which is incorporated by reference herein, including all of the documents referenced therein.

The present invention relates to devices, systems, and processes useful for connecting portable devices to power sources when used in a stationary environment and more specifically, when the connection means also includes a means to connect with peripheral devices.

2. Brief Description of the Related Art

Portable devices generally have two modes of operation. The first mode being used in a portable fashion, which is, not requiring a direct connection for power, peripheral connection or communications. The second mode is a stationary mode, where the device may be connected to a least a power source for recharging its portable power source. Additionally, the device may be connected to other devices for the exchange of data, to printers and potentially enhanced input/output devices such as keyboards, mice, displays and the like. Examples of these portable devices are: notebook computers, cell phones, personal digital assistants, remote controls, hand-held games and cordless phones. Examples of other devices to which these may be connected are: printers, networks, mice, keyboards, phone lines, etc.

In general, these devices are used in their stationary mode when their rechargeable power sources require recharging or when it is desired to utilize a communication link or enhanced input/output devices. As an example, there have been many products designed to provide an easy means to connect a notebook computer to power, input/output devices and peripherals. Examples of these are docking stations and docking bars. These devices usually have a connector that mates with a connector on the back or bottom of the notebook computer and provide connections for exchanging data, perhaps an Ethernet connector; connections to enhanced input/output devices, perhaps a Video Graphics Adapter connection for a monitor and a USB connection for a mouse; connections to a power source; and connections for peripherals, perhaps a parallel port connection for a printer. Another example of this might be a Personal Digital Assistant (PD) cradle, which might have a connector that mates to a connector on the PDA and provides power for recharging the PDA's rechargeable power source and perhaps, a serial data connection that allows the PDA to exchange data with another computing device.

Unfortunately, all of these connection systems require a physical connection through the means of a connector. This requires a docking station, docking bar or cradle equipped with that connector in a fixed position that is designed for the sole purpose of docking with a limited set of portable devices. If two portable devices are used, two docking solutions are required. Furthermore, the portable device must be mechanically mated with the docking solution and cannot easily be moved or it may be difficult to adjust its position due to the rigid location of the docking solution.

Systems have been proposed to address some of the problems associated with the connection of power to a portable device when used in a stationary mode. A company called, MobileWise, has developed a mat having a plurality of conductive bumps that are designed to mate with bumps on the bottom of a portable device. Within the mat is a controller that detects shorts that may occur when a metal object is placed on the mat and routes power to the correct bumps that are in active contact with the bumps on the bottom of the portable device. Since there are many bumps distributed over the entire mat, the portable device can be placed in many random locations and still receive power. Furthermore, multiple devices may be placed on a single mat and each receive power.

The mat described above solves the problem of connecting power to the portable devices, but many devices also require connections to other equipment and peripherals. In the example of a notebook computer, although it is nice to be able to get power and charge batteries through the described mat, most users of a notebook computer also connect printers, monitors, mice and networks while using the notebook computer in a stationary location, such as their desktop.

There therefore remains a need to provide connections to other devices in addition to providing power to the portable device.

### SUMMARY OF THE INVENTION

According to a first aspect of the invention, a method for connecting a portable device to power and peripheral devices, a mat is provided with contacts that mate with contacts on the portable device. Once contact is made with at least two contacts, power is provided for powering the portable device and for recharging its portable power source, which might be a battery. Additionally, a communication signal is modulated on the power for the purpose of communicating between the portable device and the mat. Within the portable device, there is circuitry for converting industry standard ports available within the portable device into and out of this modulated signal. Examples of these industry standard ports are USB ports, serial ports, parallel ports, PS-2 mouse/keyboard ports, Ethernet ports and the like. Within the mat, there is circuitry for converting this modulated signal back into the original industry standard signals and connecting those industry standard signals to a set of connectors intended to accept plugs for devices that follow these standards. Examples of these devices might be USB mice, parallel printers, USB printers, Ethernet connections and the like.

According to another aspect of the present invention, a mat is provided with contacts that mate with contacts on the portable device as in the previous example. Once contact is made with at least two contacts, power is provided for powering the portable device and for recharging its portable power source, which might be a battery. Additionally, a communication signal is modulated on the power for the purpose of communicating between the portable device and the mat. In the first aspect, within the portable device, was circuitry for converting industry standard ports available within the portable device into and out of this modulated signal. In this aspect of the present invention, the step of generating the industry standard ports is bypassed and the controlling logic and processing within the portable device directly outputs the modulated signal. For example, a USB port may be emulated by a driver that appears to be a USB driver to the operating system, but instead of outputting data to a physical, hardware USB port, data is written to logic that creates the modulated signal, which is later demodulated within the mat. Within the mat, there is circuitry similar to the prior aspect of this invention for converting this modulated signal back into the original industry standard signals and connecting those industry standard signals to a set of connectors intended to accept plugs for devices that follow these standards. Examples of these devices might be USB mice, parallel printers, USB printers, Ethernet connections and the like.

According to a third aspect of the present invention, communications occur in both directions, in that information may come from a device in an industry standard interface into the mat, then be modulated over the power, be demodulated within the portable device and converted back to the industry standard while, at the same time or alternating, information may come from the portable device, be modulated over the power, be demodulated within the mat, converted to the required industry standard and provided to a connector on the mat for transfer to a connected device.

According to another aspect of the present invention, a peripheral device may be housed within the mat so that when a portable device rests upon the mat and makes contact, communications is established between the portable device and the peripheral device so that the peripheral device becomes a peripheral of the portable device. For example, a thin-profile hard drive may be integrated into a mat so that when, perhaps, a music player is placed on the mat, it has access to music stored in that hard drive. The drive may be connected to the modulator/demodulator through any industry standard for drives, such as ATA, IDE, SCSI, SATA (Serial ATA) and the like. Furthermore, the drive may be any known type of drive of any size, including optical drives such as CD, CD-R, CD-RW, DVD, DVD-R, DVD+R, DVD+RW, flash drives, compact flash, memory stick, SD, and the like. Furthermore, the drive may be located internal to the mat or external without veering from the scope of the present invention.

Still other aspects, features, and attendant advantages of the present invention will become apparent to those skilled in the art from a reading of the following detailed description of embodiments constructed in accordance therewith, taken in conjunction with the accompanying drawings. It will also become apparent that one portable device may have several ports connected through the mat. As an example, a notebook computer may have connections for networking, a printer, a mouse and the like. It will also become apparent that more than one portable device may be placed on a single mat and perhaps share connections to peripherals or exchange data between those portable devices. An example of this would be a notebook computer and a PDA. In this case, a connection may be made from the notebook computer to the PDA for the purpose of synchronizing files, while the notebook may also be connected to a network, a printer, a mouse and the like. Furthermore, the PDA may also use the connection to the printer and in that case, the mat would have intelligence for arbitrating between the PDA and notebook computer when both devices try to use the same peripheral.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 schematically illustrates an exemplary top view of a charging mat in accordance with the present invention.

FIG. 2 schematically illustrates the bottom of a portable device relating to an aspect of the present invention.

FIG. 3 schematically illustrates the prior art which comprises providing power and charge to a portable device through a charging mat.

FIG. 4 schematically illustrates a method of providing communications between the portable device and the ports on the charging mat relating to an aspect of the present invention.

FIG. 5 schematically illustrates an exemplary back view of a charging mat according to the prior art.

FIG. 6 schematically illustrates an exemplary back view of a charging mat according to the present invention.

### DESCRIPTION OF THE PREFERRED EMBODIMENTS

Referring to the drawing figures, like reference numerals designate identical or corresponding elements throughout the several figures.

In general terms, one aspect of the present invention is providing input/output connections between a portable device and peripherals that may be stationary, perhaps on a desk, through a mat. This mat may also provide power to the portable device for operation and for charging its internal power source. In some embodiments of the invention, a single device may be connected through the mat. An example of this may be when a PDA is set upon the mat; the PDA's batteries receive charging power through the mat while the PDA may communicate with another computer through the mat, connected via a standard interface such as a USB port or Serial Port, possibly to exchange files. In other embodiments of the present invention, the portable device may be connected to a plurality of devices through the mat. An example of this may be a notebook computer is set upon the mat; the notebook computer's batteries receive charging power through the mat while the notebook computer connects with a mouse and printer through the mat; the mouse connected to a USB port and the printer connected to a parallel port.

One aspect of the present invention is that more than one portable devices may be set upon a single charging mat. In this aspect, both devices may receive operating and charging power while both devices may also connect with devices such as printers, mice, displays, networks and the like. Furthermore, in this aspect, the more than one portable device may also communicate with each other through the single charging mat.

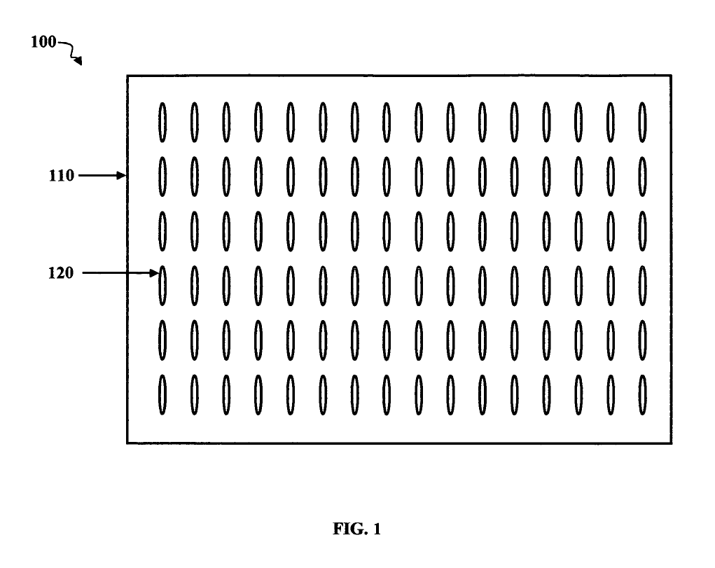

Turning now to the drawing figures, exemplary embodiments and aspects of the present invention are schematically and diagrammatically illustrated. In FIG. 1, a charging mat 110 is shown from the top view and includes a plurality of contacts or bumps 120. Those of skill in the art are well acquainted with the construction and use these conductive contacts for the transfer of power and communications that will be discussed so that aspects of the present invention are not obscured.

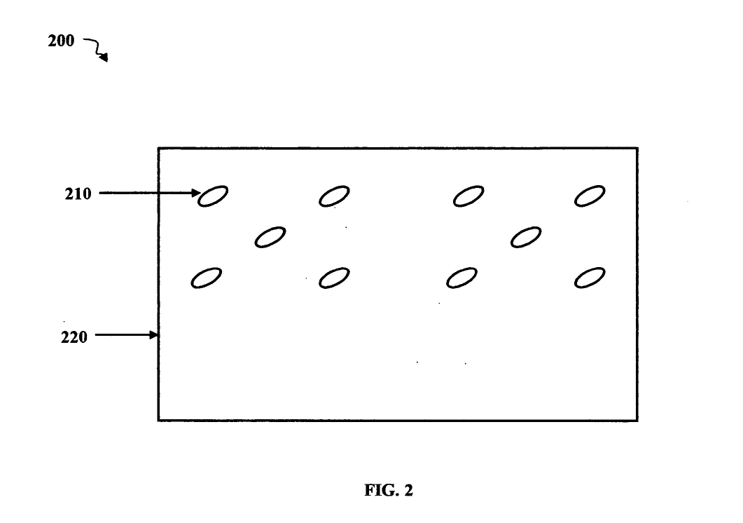

FIG. 2 shows an exemplary embodiment of the contact side of a portable device 220. In this figure, there are also conductive contacts 210 located on the surface of the portable device 220 and positioned so that when that surface of the portable device 220 rests upon the top surface of the charging mat 110, contact is made between at least two of contacts 120 and contacts 210, providing a closed circuit to allow power and data to transfer between the charging mat 110 and the portable device 220.

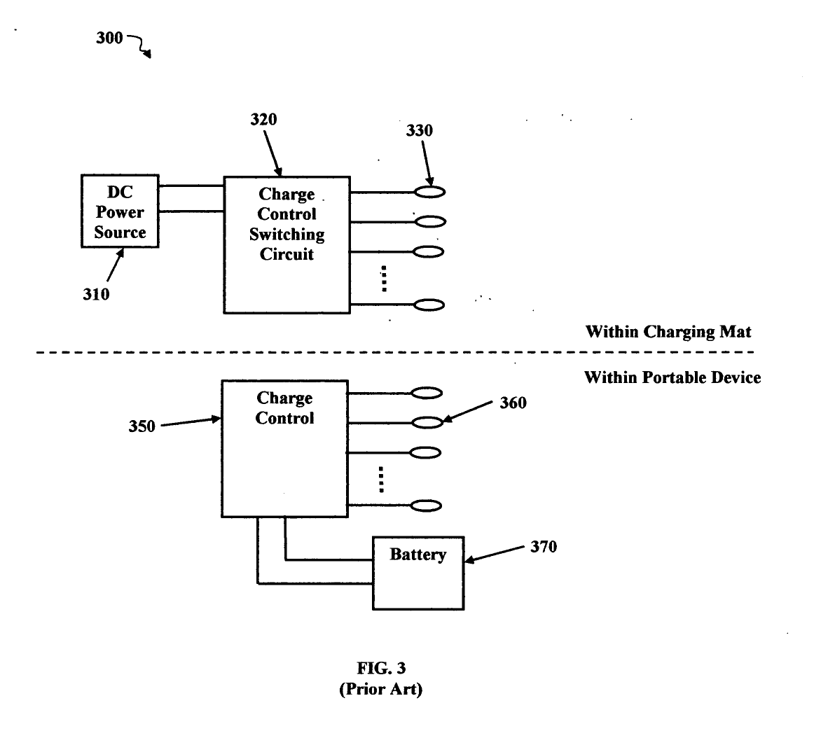

Turning now to FIG. 3, the use of the exemplary embodiment illustrated in FIGS. 1 and 2 will be explained. FIG. 3 is here to show how it is believed that the prior art functions. The prior art only provides power to the portable device for operating and charging batteries. Referring to the top half of FIG. 3, circuitry that may be stationary and associated with the charging mat is discussed. Connected to mat contacts 330 of mat 110 from FIG. 1 is charge control switching circuit 320. The charge control switching circuit receives power from a DC power source 310, which may be integral to the charging mat or external, perhaps in the form of a power brick or other power supply. Charge control switching circuit 320 manages transmission of electric power to each individual mat contact 330 locate on the surface of mat 110. Now, referring to the bottom portion of FIG. 3, circuitry that may be associated with the portable device is discussed. Connected to the device contacts 360 that may be positioned in various locations on the bottom of the portable device is a charge control circuit 350. This charge control circuit manages power received from the device contacts 360 and powers the portable device and/or charges a rechargeable power source within the portable device. In this example, it is shown that only a battery 370 is being charged. The charge control switching circuit 320 determines which of individual mat contacts 330 are in contact with individual device contacts 360 and routes power to these contacts. The charge control switching circuit 320 is also responsible for detecting a short circuit between any mat contacts 330 and disconnecting power to those contacts until the short circuit subsides.

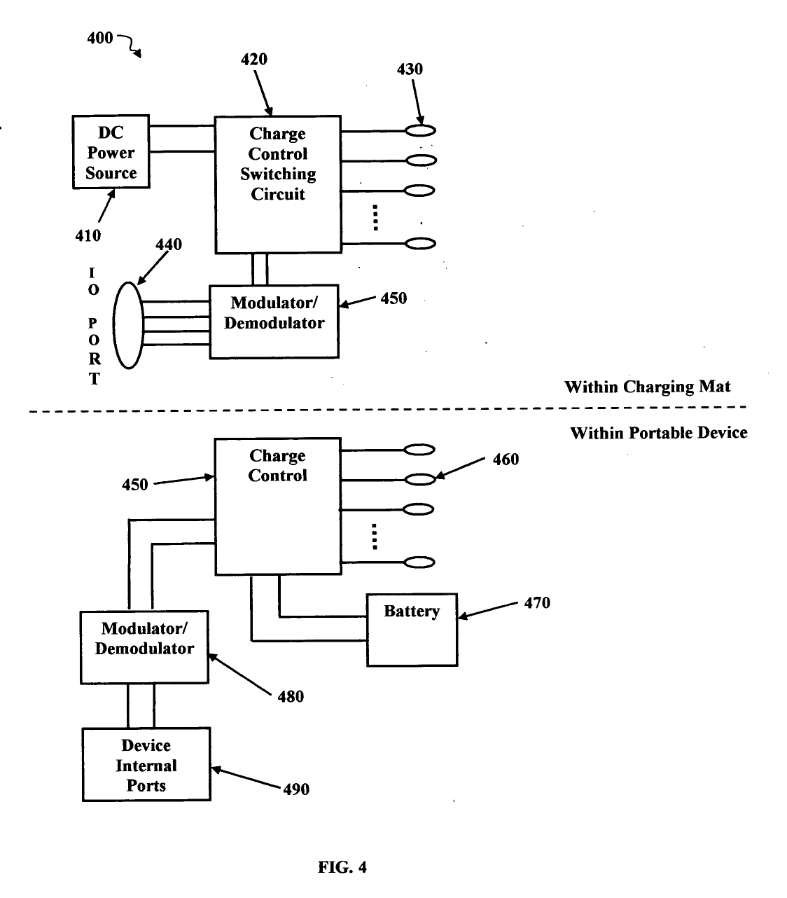

Turning now to FIG. 4, the use of the exemplary embodiment illustrated in FIGS. 1 and 2 will be explained. FIG. 4 shows additional circuitry added to that which is shown in FIG. 3 so that the portable device may be communicatively connected to peripheral devices through the charging mat. Referring to the top half of FIG. 4, circuitry that may be stationary and associated with the charging mat is discussed. Connected to mat contacts 430 of mat 110 from FIG. 1 is charge control switching circuit 420. The charge control switching circuit receives power from a DC power source 410, which may be integral to the charging mat or external, perhaps in the form of a power brick or other power supply. Charge control switching circuit 420 manages transmission of electric power to each individual mat contact 430 locate on the surface of mat 110. Modulator/Demodulator 450 adds communications functionality to the charging mat and manages transmission of data over the power connections between the charging mat and the portable device. Although it is shown that DC power is provided to contacts 430, it is also possible to provide AC power instead. It is well known how to share the same transmission medium between AC or DC power and data as evident by home power line networking and by remote telemetry devices that use only two wires to carry both power and data. Modulator/Demodulator 450 converts data back and forth between a modulated signal that is sent/received from the portable device to any desired format. In the case of a portable computer such as a notebook computer, the modulated signal may be converted to a few different industry standard formats such as USB, Ethernet, IEEE 1285 parallel port, RS-232 Serial port, or the like. Connectors may be provided within the mat for connection to devices that conform to these standards, perhaps mice, printers or networks. Now, referring to the bottom portion of FIG. 4, circuitry that may be associated with the portable device is discussed. Connected to the device contacts 460 that may be positioned in various locations on the bottom of the portable device is a charge control circuit 450. This charge control circuit manages power received from the device contacts 460 and powers the portable device and/or charges a rechargeable power source within the portable device. In this example, it is shown that only a battery 470 is being charged. The charge control switching circuit 420 determines which of individual mat contacts 430 are in contact with individual device contacts 460 and routes power and modulated data to these contacts. The charge control switching circuit 420 is also responsible for detecting a short circuit between any mat contacts 430 and disconnecting power to those contacts until the short circuit subsides. Within the portable device is a second modulator/demodulator 480 which is connected to the device contacts 460 through charge control 450. This second modulator/demodulator sends and receives data from the portable device, over the power connection, to the charging mat. The second modulator/demodulator 480 may get its input/output from device ports that are internal to the portable device 490 or these ports may be virtualized. For example, a notebook computer may have four individual USB ports available from its chipset. Three may be used for port connections on the outside of the portable, perhaps two on the side and one in the back, while the fourth may be connected to the second modulator/demodulator 480 for use when the portable device rests on the charging mat. Alternately, the chipset may have only enough USB ports to support fixed connectors on the chassis of the portable device. In this case, the second modulator/demodulator 480 may be connected to a high speed data bus within the portable computing system and may emulate several ports, perhaps a USB port and an Ethernet port, for example only.

Although it has been shown that a portable device resting on the charging mat may be provided with power as well as communications capabilities for connection to peripherals, devices and networking, there are other uses for the basic capabilities provided. For example, two portable devices may be set upon a single charging mat and their modulators/demodulators may be communicatively coupled as to provide a data connection between the two devices without any intervention by the charging mat circuitry. This would be useful, as example, when a notebook computer is set beside a portable digital assistant (PDA) and these devices need to share data and/or files.

It may also be envisioned that devices may reside within the charging mat itself and used by the portable device when it rests on the charging mat. For example, the charging mat may contain a storage device such that when a portable device is placed on that charging mat, the storage device may be accessed by the portable device. An example of this might be where the storage device contains a large amount of content, such as music files and the portable device is a music player. Music files may be transferred between the storage device and the music player while the music player rests on the charging mat.

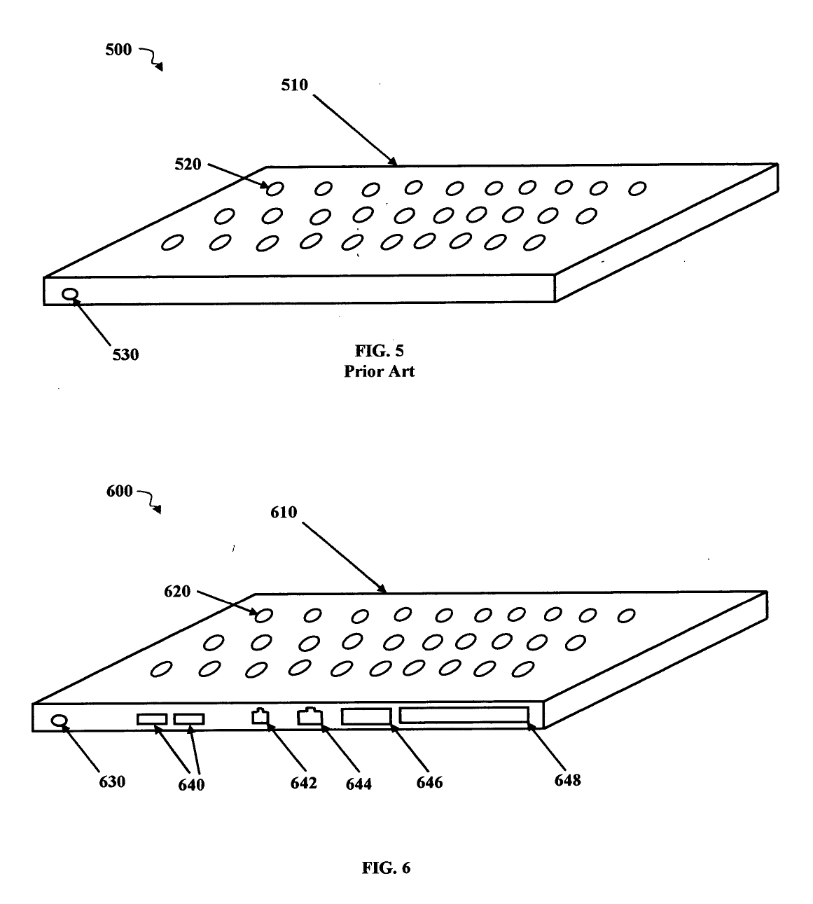

FIG. 5 shows a charging mat according to the prior art. In this example, the Charge Control Circuit is embedded within the charging mat 510 and connected to a plurality of contacts 520. Power is provided through connector 530, and may come from a DC power brick or wall adapter. This system, according to the prior art, provides only power to a device that rests upon the charging mat.

FIG. 6 shows a possible charging mat 610 according to the present invention. In this example, the charge control circuitry and modulator/demodulator (not shown) may be embedded within the charging mat or may be in a separate housing that itself may be attached to the charging mat or separate and are connected to contacts 620. In this example, power is provided through connector 630, and may come from a DC power brick, wall adapter or other source. In this example, a variety of connectors are shown spaced across the back of the charging mat 610. The connectors shown are: USB connectors 640, Modem connector 642, Ethernet connector 644, Serial Port connector 646 and Parallel Port connector 648. Each of these connectors is internally connected to the modulator/demodulator circuit. It is to be known that these are examples of possible connectors and in any given charging mat; there may be more or less connectors or types of connectors. For example, some embodiments may also include a video graphics port (VGA). Furthermore, instead of connectors, the charging mat may have a captured cable that plugs into another device. For example, instead of having an Ethernet connector, the charging mat may have an Ethernet Cable emanating from it with an RJ-45 plug at the far end for connection to a network jack.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A charging mat system comprising:
a charging mat, wherein said charging mat is configured with a plurality of conductive contacts disposed on a top planar surface;
a charging circuit configured to selectively provide power to said plurality of conductive contacts, said charging circuit being connected to said plurality of conductive contacts;
a modulator/demodulator for converting between demodulated data and modulated data, wherein said modulator/demodulator is configured to be connected with said charging mat for sending and receiving data via said plurality of conductive contacts;
a data conversion circuit connected to said modulator/demodulator and to at least one industry standard interface, said data conversion circuit converting between said demodulated data and said at least one industry standard interface; and
at least one industry standard interface connector connected to said data conversion circuit.

2. A charging mat system according to claim 1, wherein modulator/demodulator uses frequency modulation to send data over said power and receive data from said power.

3. A charging mat system according to claim 1, wherein said at least one industry standard interface connector is one of: Universal Serial Bus, Serial Port, Parallel Port, PS-2 Mouse Port, PS-2 Keyboard Port, Ethernet Port, Token Ring Port, Video Graphics Adapter (VGA) Port, IEEE 1394 Port, Firewire Port, Compact Flash Port, Memory Stick Port, CardBus Port and PCMCIA Port.

4. A charging mat system according to claim 1, wherein said industry standard interface connector is connected to said charging mat system through a cable.

5. A charging mat system according to claim 1, wherein said industry standard interface connector is mounted to said charging mat system.

6. A charging mat system according to claim 1, wherein said charging circuit is housed within said mat.

7. A charging mat system according to claim 1, further comprising:
a portable device, said portable device further comprising:
a bottom planar surface, said bottom planar surface being substantially parallel with said top planar surface of said charging mat;
a plurality of bottom surface contacts located on said bottom planar surface, at least two of said plurality of bottom surface contacts coming into contact with at least two of said plurality of conductive contacts providing a closed circuit;
a power control circuit for extracting power from said closed circuit; and
a portable device modulator/demodulator for modulating and demodulating data over said closed circuit.

8. A charging mat system according to claim 7, wherein said at least one industry standard interface connector is on of: Universal Serial Bus, Serial Port, Parallel Port, PS-2 Mouse Port, PS-2 Keyboard Port, Ethernet Port, Token Ring Port, Video Graphics Adapter (VGA) Port, IEEE 1394 Port, Firewire Port, Compact Flash Port, Memory Stick Port, CardBus Port and PCMCIA Port.

9. A charging mat system according to claim 7, wherein said industry standard interface connector is connected to said charging mat system through a cable.

10. A charging mat system according to claim 7, wherein said industry standard interface connector is mounted to said charging mat system.

11. A charging mat system according to claim 7, wherein said charging circuit is housed within said mat.

12. A portable device comprising:
a bottom planar surface;
a plurality of bottom surface contacts located on said bottom planar surface;
a power control circuit for extracting power from at least two of said bottom surface contacts; and
a portable device modulator/demodulator for modulating and demodulating data over said power.

13. A portable device according to claim 12, wherein said portable device modulator/demodulator uses frequency modulation to send data over the power and receive data from the power.

14. A portable device according to claim 12, further comprising a processor, wherein said portable device modulator/demodulator is connected to an input/output port or said processor.

15. A portable device according to claim 12, wherein said input/output port of said processor is any one of: Universal Serial Bus, Serial Port, Parallel Port, PS-2 Mouse Port, PS-2 Keyboard Port, Ethernet Port, Token Ring Port, Video Graphics Adapter (VGA) Port, IEEE 1394 Port, Firewire Port, Compact Flash Port, Memory Stick Port, CardBus Port and PCMCIA Port.

16. A method for providing power and interface ports to a portable device without using plugs or jacks located on said portable device, comprising:
providing a charging mat, said charging mat having a first plurality of contacts located upon its top planar surface and said first plurality of contacts being selectively provided power and data communications; and
placing a portable device on said charging mat, said portable device having a second set of contacts located upon its bottom planar surface, and at least two of said second set of contacts mating with at least two of said first set of contacts and said second set of contacts providing a closed circuit, said closed circuit providing power and communications to said portable device.

17. A method for providing power and interface ports to a portable device without using plugs or jacks located on said portable device as in claim 16, further comprising:
plugging at least one industry standard interface jack into at least one plug and jack located on said charging mat.

18. A method for providing power and interface ports to a portable device without using plugs or jacks located on said portable device as in claim 17, wherein said at least one industry standard jack is one of: Universal Serial Bus, Serial Port, Parallel Port, PS-2 Mouse Port, PS-2 Keyboard Port, Ethernet Port, Token Ring Port, Video Graphics Adapter (VGA) Port, IEEE 1394 Port, Firewire Port, Compact Flash Port, Memory Stick Port, CardBus Port and PCMCIA Port.

19. A means for connecting a portable device to power and at least one peripheral interface comprising:
a charging mat means for providing power and connections to said at least one peripheral interface through a first plurality of contacts, said first plurality of contacts reside upon a top planar surface of said charging mat; and
a means to connect said first plurality of contact to a second plurality of contacts, said second plurality of contacts residing upon a bottom planar surface of said portable device, wherein, at least two of said first plurality of contacts comes in contact with at least two of said second plurality of contacts, thereby providing a closed circuit for providing power from said charging mat to said portable device and for providing a communication means for connecting said at least one peripheral interface to said portable device.

20. A means for connecting a portable device to power and at least one peripheral interface according to claim 19, wherein said communication means includes frequency modulation over said closed circuit.

21. A means for connecting a portable device to power and at least one peripheral interface according to claim 19, wherein said at least one peripheral is one of: Universal Serial Bus, Serial Port, Parallel Port, PS-2 Mouse Port, PS-2 Keyboard Port, Ethernet Port, Token Ring Port, Video Graphics Adapter (VGA) Port, IEEE 1394 Port, Firewire Port, Compact Flash Port, Memory Stick Port, CardBus Port and PCMCIA Port.

22. A means for connecting a portable device to power and at least one peripheral interface according to claim 19, wherein said at least one peripheral interface is provided through a connector, said connector is mounted along an edge of said charging mat.

23. A means for connecting a portable device to power and at least one peripheral interface according to claim 19, wherein said peripheral interface is IDE and said peripheral interface is connected to a drive that is mounted within said charging mat means.

24. A means for connecting a portable device to power and at least one peripheral interface according to claim 19, wherein said peripheral interface is IDE and said peripheral interface is connected to a drive that is mounted external to said charging mat means.

25. A means for connecting a portable device to power and at least one peripheral interface according to claim 19, wherein said peripheral interface is SCSI and said peripheral interface is connected to a drive that is mounted within said charging mat means.

26. A means for connecting a portable device to power and at least one peripheral interface according to claim 19, wherein said peripheral interface is SCSI and said peripheral interface is connected to a drive that is mounted external to said charging mat means.

27. A means for connecting a portable device to power and at least one peripheral interface according to claim 19, wherein said peripheral interface is Serial ATA and said peripheral interface is connected to a drive that is mounted within said charging mat means.

28. A means for connecting a portable device to power and at least one peripheral interface according to claim 19, wherein said peripheral interface is Serial ATA and said peripheral interface is connected to a drive that is mounted external to said charging mat means.
